(19) United States
(12) Patent Application Publication
(10) Pub. No.: US 2012/0195065 A1
(43) Pub. Date: Aug. 2, 2012

(54) LIGHT GUIDE PLATE, SURFACE LIGHT SOURCE DEVICE, TRANSMISSION-TYPE IMAGE DISPLAY DEVICE, METHOD OF MANUFACTURING LIGHT GUIDE PLATE, AND ULTRAVIOLET CURING TYPE INK-JET INK FOR LIGHT GUIDE PLATE

(75) Inventors: Kentarou HYAKUTA, Niihama-shi (JP); Hideyuki TERASAWA, Fukui-Shi (JP)

(73) Assignees: SEIREN CO., LTD., Fukui-Shi (JP); SUMITOMO CHEMICAL COMPANY, LIMITED, Tokyo (JP)

(21) Appl. No.: 13/364,863

(22) Filed: Feb. 2, 2012

(30) Foreign Application Priority Data
Feb. 2, 2011 (JP) 2011-020956

(51) Int. Cl. F21V 8/00; C09D 11/10; B05D 5/06

(52) U.S. Cl. 362/602; 362/624; 427/164; 522/9

(57) ABSTRACT

The present invention provides a light guide plate capable of emitting light from a light-emitting surface at a higher luminance, a surface light source device and a transmission-type image display device having the light guide plate, a light guide plate manufacturing method, and a UV curable inkjet ink for the light guide plate. A light guide plate includes: a transparent resin sheet having a light-emitting surface that emits light incident from an end face and having a rear face on the opposite side of the light-emitting surface; and a plurality of reflective dots provided on the rear face of the transparent resin sheet and formed by photo-curing of dot-shaped ink. The ink contains a pigment, a photopolymerizable component, and a photopolymerization initiator. In addition, the rear face is a liquid repellent-treated surface.

### BACKGROUND OF THE INVENTION

1. Field of the Invention

The present invention relates to a light guide plate, a surface light source device, a transmission-type image display device, a method of manufacturing light guide plate, and a ultraviolet curing type ink-jet ink for the light guide plate.

2. Description of the Related Art

A transmission-type image display device such as a liquid-crystal display device generally has a surface light source device as a backlight. An edge-light type surface light source device includes a light guide plate having a transparent resin sheet and a light source for supplying a light to the end face of the transparent resin sheet. The light which has been incident from the end face of the transparent resin sheet is reflected by reflection means such as reflective dots provided on the rear face side of the transparent resin sheet, and a planar light for image display is supplied from an exit face of the light guide plate.

A method of applying an ink-jet printing using ink jet ink is proposed as a method of forming reflective dots (orientation patterns) (Japanese Patent Application Laid-open Publication No. 2006-136867, Japanese Patent Application Laid-open Publication No. 2004-240294). The ink-jet printing is expected to be capable of easily forming the reflective dots having a configuration of a desired pattern.

### SUMMARY OF THE INVENTION

However, in a case where light is emitted using a light guide plate having reflective dots formed by inkjet printing, luminance tends to be low owing to an inability to extract sufficient light supplied to the light guide plate onto the light-emitting surface of the light guide plate.

In consideration thereof, an object of the present invention is to provide a light guide plate capable of emitting light from a light-emitting surface at a higher luminance, a surface light source device and a transmission-type image display device comprising the light guide plate, a method of manufacturing light guide plate, and a ultraviolet curing type ink-jet ink for the light guide plate.

The present invention relates to a light guide plate comprising: a transparent resin sheet having a light-emitting surface that emits light incident from an end face and having a rear face on the opposite side of the light-emitting surface; and a plurality of reflective dots provided on the rear face of the transparent resin sheet and formed by photo-curing of dot-shaped ink, wherein the ink contains a pigment, a photopolymerizable component, and a photopolymerization initiator, and the rear face is a liquid repellent-treated surface.

With the light guide plate according to the present invention, reflective dots constituted by the photo-curing of the ink are formed on the liquid repellent-treated rear face of the transparent resin sheet. Accordingly, since the reflective dots are suppressed from connecting with each other, a greater amount of light can be extracted from the light-emitting surface. As a result, light can be emitted from the light-emitting surface at a higher luminance.

With the light guide plate according to the present invention, preferably, the rear face is a surface that is liquid repellent-treated so that a droplet of water dropped on the rear face has a contact angle of 80 to 130 degrees. Accordingly, the reflective dots can be more reliably suppressed from connecting with each other.

With the light guide plate according to the present invention, preferably, a percentage of adjacent reflective dots connected to each other is 0 to 30 per 100 reflective dots. If the percentage of adjacent reflective dots connected to each other is in the range described above, the influence of the reflective dots connecting with each other on luminance degradation is suppressed.

In another aspect, the present invention relates to a method of manufacturing light guide plate comprising the steps of: performing liquid repellent treatment on one surface of a transparent resin sheet;

printing a pattern with the ink on the one liquid repellent-treated surface by inkjet printing; and forming reflective dots by photo-curing the printed pattern of ink, wherein the ink contains a pigment, a photopolymerizable component, and a photopolymerization initiator.

With the manufacturing method according to the present invention, reflective dots are formed by the ink on one liquid repellent-treated surface of the transparent resin sheet. Accordingly, a light guide plate in which reflective dots are suppressed from connecting with each other can be manufactured. With a light guide plate manufactured in this manner, a greater amount of light can be extracted from the light-emitting surface and light can be emitted at a higher luminance.

In yet another aspect, the present invention relates to a surface light source device comprising: the light guide plate according to the present invention; and a light source for supplying light to the end face of a transparent resin sheet included in the light guide plate. Since the surface light source device comprises the light guide plate according to the present invention, a greater amount of light supplied from the light source can be extracted from the light-emitting surface of the transparent resin sheet. As a result, the surface light source device according to the present invention is capable of emitting light at a higher luminance.

In yet another aspect, the present invention relates to a transmission-type image display device comprising: the light guide plate according to the present invention; a light source for supplying light to the end face of a transparent resin sheet included in the light guide plate; and a transmission-type image display unit illuminated by light emitted from a light-emitting surface of the transparent resin sheet included in the light guide plate.

Since the transmission-type image display device according to the present invention comprises the light guide plate according to the present invention, light supplied from the light source can be emitted from the light-emitting surface of the transparent resin sheet at a higher luminance. Therefore, the transmission-type image display device can be illuminated at a higher luminance.

In still another aspect, the present invention relates to a ultraviolet curing type ink-jet ink which is applied to become reflective dots on one liquid repellent-treated surface of a transparent resin sheet, wherein the ultraviolet curing type ink-jet ink contains a pigment, a photopolymerizable component, and a photopolymerization initiator, and the pigment is at least one of calcium carbonate particles, barium sulfate particles, and titanium dioxide particles.

The ultraviolet curing type ink-jet ink for a light guide plate according to the present invention is applied to become reflective dots to the liquid repellent-treated surface of the transparent resin sheet. Since the ultraviolet curing type ink-jet ink for a light guide plate according to the present invention includes the pigment, when light is supplied to a light guide plate comprising the transparent resin sheet and the reflective dots, light can be emitted from a light-emitting surface of the transparent resin sheet at a higher luminance.

### BRIEF DESCRIPTION OF THE DRAWINGS

FIG. 1 is a cross-sectional view showing an embodiment of a transmission-type image display device comprising a surface light source device;

FIG. 2 is a plan view of a side of a light guide plate on which reflective dots are formed;

FIG. 3 is a perspective view showing an embodiment of a light guide plate manufacturing method;

FIG. 4 is a table showing results of yellow index measurements of light guide plates of first to fifth examples;

FIG. 5 is a table showing results of luminance measurements of the first to fifth examples; and

FIG. 6 is a table showing results of luminance measurements of first to sixth comparative examples.

### DESCRIPTION OF THE PREFERRED EMBODIMENT

An embodiment of the present invention will now be described in detail. However, the present invention is not limited to the following embodiment. In the description of the drawings, identical elements will be denoted by identical reference characters to omit redundancy. In addition, it should be noted that the dimensional ratios presented in, the drawings are not necessary consistent with those used in the description. In the explanation of the embodiment, “ultraviolet” is referred to as “UV.”

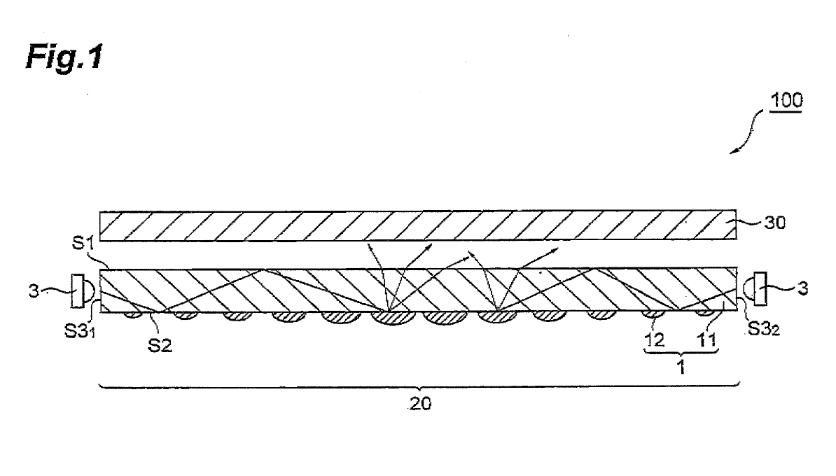

FIG. 1 is a cross-sectional view showing a transmission-type image display device comprising an embodiment of a light guide plate according to the present invention. The transmission-type image display device 100 illustrated in FIG. 1 is mainly constituted by a surface light source device 20 and a transmission-type image display unit 30. The surface light source device 20 is an edge-light type surface light source device including a light guide plate 1 having a transparent resin sheet 11 and a light source 3 which is provided to the side of the light guide plate 1 and which supplies light to the light guide plate 1.

The transparent resin sheet 11 has an approximately cuboid shape. The transparent resin sheet 11 has an exit face S1, a rear face S2 in, the opposite side of the exit face S 1, and four end faces S3₁ to S3₄ that intersect the exit face S1 and the rear face S2. In the present embodiment, the four end faces S3₁ to S3₄ are approximately orthogonal to the exit face S1 and the rear face S2.

The transparent resin sheet 11 is preferably a poly(meth)alkyl acrylate resin sheet, a polystyrene sheet or a polycarbonate-based resin sheet, and among then, polymethyl methacrylate resin sheet (PMMA resin sheet) is preferable. The transparent resin sheet 11 may also contain diffusing particles. The surface (exit face S1) in the opposite side of a surface (rear face S2) of the transparent resin sheet 11, on which the reflective dots 12 are formed, may be a flat surface as described in the present embodiment, but may also have a shape of concavity and covexity. The transparent resin sheet 11 preferably has a thickness of 1.0 mm to 4.5 mm.

The rear face S2 of the transparent resin sheet 11 is a surface almost entirely subjected to liquid repellent treatment. The liquid repellent treatment applied to the rear face S2 is a liquid repellent treatment in which a drop of water dropped on the rear face S2 has a contact angle of 80 to 130 degrees, preferably a contact angle of 85 to 120 degrees, or more preferably a contact angle of 90 to 110 degrees. In the present embodiment, a contact angle refers to a static contact angle. Details of a method of measuring the contact angle will be described later in the examples.

The light guide plate 1 further has a plurality of reflective dots 12 provided on the side of the rear face 82. A maximum thickness of each reflective dot 12 is preferably 20 μm or less or more preferably 15 μm or less.

The yellow index is preferably 10 or less, which is evaluated on the basis of the spectral transmittance measurement of a light which has transmitted through the reflective dots 12 and the transparent resin sheet 11 in a perpendicular line direction of the exit face S1. The above described yellow index can be measured by printing an ink-jet ink used for forming the reflective dots on an the whole one side of the transparent resin sheet, curing the printed ink to prepare a sample for measurement, which has a reflective film having the same thickness as that of the reflective dots, and using the sample for measurement. The yellow index of 10 or less can be easily achieved, for instance, by the combination of the PMMA resin sheet with an ink-jet ink which will be described later. The details of the method for measuring the yellow index will be described in Examples which will be described later.

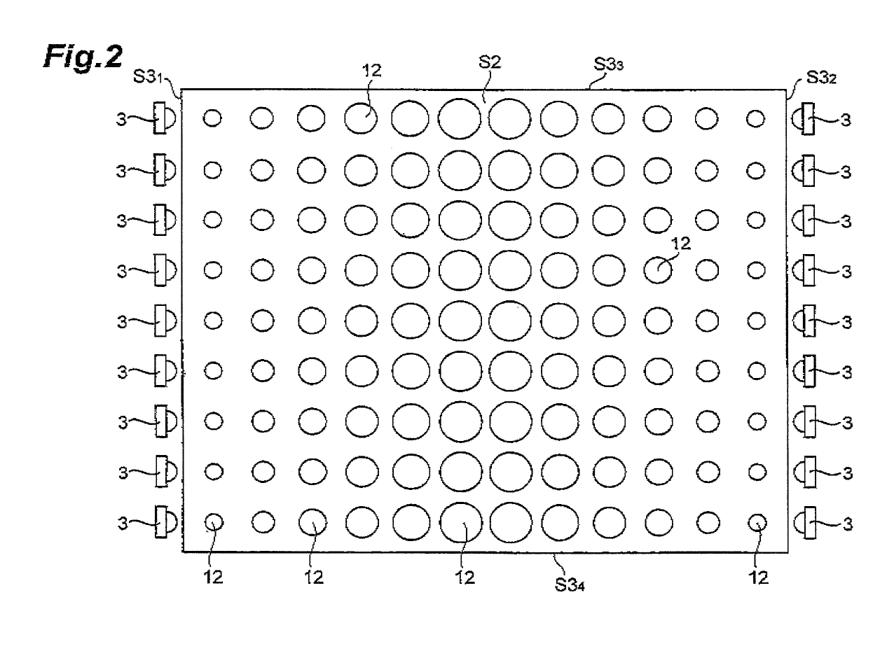

As shown in FIG. 2, the plurality of reflective dots 12 are arranged separated from each other on the rear face 52. FIG. 2 is a plan view of the light guide plate as seen from the side of the rear face. FIG. 2 also shows the light source 3 for the sake of convenience of explanation. In FIG. 2, the reflective dots 12 are arranged separated from each other. However, the percentage of reflective dots 12 connected to each other on a surface on which the reflective dots 12 are formed may be 0 to 30 per 100 reflective dots 12 in a vicinity of a given position, preferably 0 to 20 reflective dots 12 are connected to each other, or more preferably 0 to 10 reflective dots 12 are connected to each other. It is preferable that the 100 reflective dots 12 selected for evaluating the percentage of reflective dots 12 connected to each other are 100 reflective dots 12 on the rare face 52 in an area where the reflective dots 12 are more densely arranged. The number and the like of reflective dots 12 shown in FIG. 2 are for the sake of convenience of explanation and, as will be described later, the number and arrangement pattern of the reflective dots 12 are adjusted so that a uniform planar light is efficiently emitted from the exit face S1.

As shown in FIGS. 1 and 2, the light source 3 is arranged lateral to a pair of end faces S3₁ and S3₂ which oppose each other. While the light source 3 may be a linear light source such as a cold cathode fluorescent lamp (CCFL), it is preferable that the light source 3 is a point light source such as an LED. In this case, as shown in FIG. 2, a plurality of point light sources are arranged along two sides that oppose each other among four sides constituting, for example, a rectangular rear face S2 of the transparent resin sheet 11. Combining reflective dots 12 formed by an ink-jet ink to be described later) and LEDs is particularly advantageous for the purpose of obtaining natural color tone light.

As shown in FIG. 1, the transmission-type image display unit 30 is arranged so as to oppose the light guide plate 1 on the side of the exit face S1 of the light guide plate 1. For example, the transmission-type image display unit 30 is a liquid crystal display unit having liquid crystal cells.

In the configuration described above, light emitted from the light source 3 is incident to the transparent resin sheet 11 from the end faces S3₁ and S3₂. The light incident to the transparent resin sheet 11 is irregularly reflected by the reflective dots 12 and primarily emitted from the exit face S1. The light emitted from the exit face S1 is supplied to the transmission-type image display unit 30. The number and arrangement pattern of the reflective dots 12 are adjusted so that a uniform planar light is efficiently emitted from the exit face S1.

Next, a manufacturing method of the light guide plate 1 will be described. When manufacturing the light guide plate 1, first, a liquid repellent treatment is applied to a surface of the transparent resin sheet 11 included in the light guide plate 1 that becomes the rear face 52 of the transparent resin sheet 11. For the sake of convenience of explanation, the surface (one surface) of the transparent resin sheet 11 on which the liquid repellent treatment is performed will be referred to as a surface S0.

As described earlier, the degree of liquid repellent treatment is such that a drop of water chopped on the liquid repellent-treated surface S0 of the transparent resin sheet 11 has a contact angle of 80 to 130 degrees, preferably a contact angle of 85 to 120 degrees, or more preferably a contact angle of 90 to 110 degrees. By setting the contact angle to 80 degrees or more, the reflective dots 12 can be prevented from connecting with each other and, the reflective dots 12 can be provided more densely. Furthermore, by setting the contact angle to 130 degrees or less, the adherence between the reflective dots 12 and the transparent resin sheet 11 can be maintained at a high level.

Examples of the liquid repellent treatment include a treatment using a surface modifier as a liquid repellent treatment agent, a treatment by various energy rays, a treatment by chemisorption, and a treatment by graft polymerization on a material surface.

A treatment using a surface modifier is a treatment where a liquid-repellent layer to which a small amount of a surface modifier is added is formed on the surface S0 of the transparent resin sheet 11. Examples of a surface modifier as a liquid repellent treatment agent include a vinyl-based polymer having a perfluoroalkyl group (Rf group) or an Rf group-containing silicone. The liquid-repellent layer can be formed by instilling the surface modifier into a paper rag or the like and applying the surface modifier to the surface S0, spraying the surface modifier onto the surface S0 using a spray or by inkjet printing, or the like.

A treatment by various energy rays is a treatment where the surface S0 is given a liquid-repellent property by an energy ray. Examples of an energy ray include plasma, an electron beam, and an ion beam. In a case where plasma treatment is adopted, examples of liquid repellent treatment include roughening the surface S0 by plasma etching and subsequently forming a liquid repellent monomolecular film or the like on the roughened surface, fluorinating the surface S0 with a fluorine-based gas plasma, forming a coat constituted by a liquid-repellent compound on the surface S0 by plasma CVD, and forming a liquid-repellent thin film on the surface S0 by plasma polymerization.

Examples of a treatment by surface roughening are giving a shape of concavity and convexity to the surface S0 of the transparent resin sheet 11 by hot pressing, etching with a chemical, or blasting.

When performing a treatment by chemisorption, it is preferable that ends of admolecules are modified by fluorine. In particular, the CF3 group is favorable as a terminal substituent from the perspective of a liquid repellent property.

Among the treatment examples described above, fluorination of the surface S0 with a fluorine-based gas plasma is preferable because surface treatment can be carried out in a simple and uniform manner.

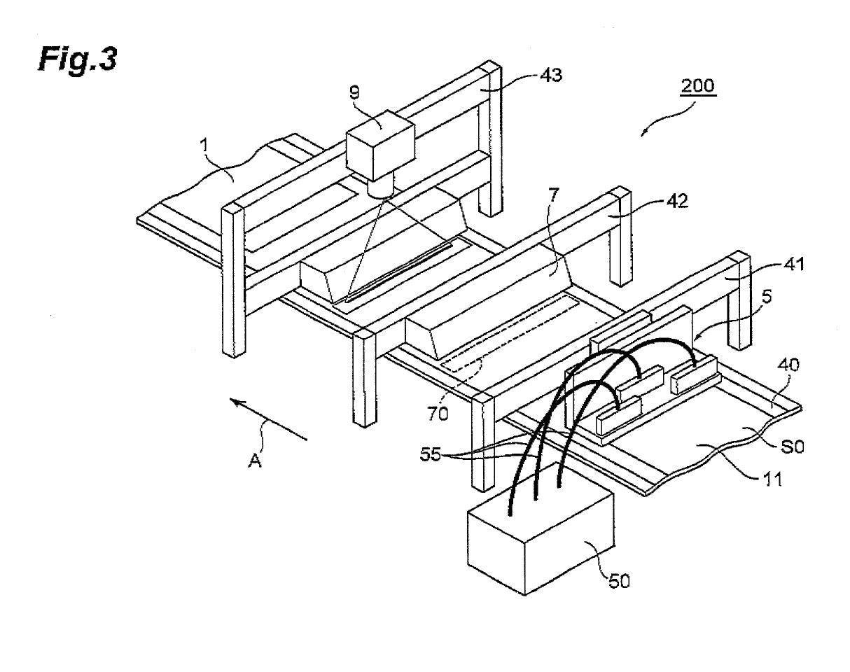

As shown in FIG. 3, the light guide plate 1 is manufactured by forming reflective dots 12 on the surface S0 of the transparent resin sheet 11 applied to a liquid repellent treatment as described above. FIG. 3 is a perspective view illustrating one embodiment of a method for manufacturing a light guide plate.

An device 200 illustrated in FIG. 3 for manufacturing the light guide plate is structured by transporting means 40 for transporting the transparent resin sheet 11, an ink-jet head 5, a UV lamp 7 and an inspection device 9. The ink-jet head 5, the UV lamp 7 and the inspection device 9 are arranged sequentially in this order from the upstream side in a moving direction A of the transparent resin sheet.

The transparent resin sheet 11 is continuously or intermittently transported along the direction A by the transporting means 40. The transparent resin sheet 11 may also be previously cut so as to match the size of the light guide plate to be manufactured, or may also be cut after the reflective dots 12 have been formed on the long transparent resin sheet 11. The transporting means 40 in the present embodiment is a table shuttle, but is not limited to it, and may also be, for instance, a belt conveyor, a roller or an air levitation transfer.

A droplet ink-jet ink is deposited on the surface S0 of the transparent resin sheet 11 by the ink-jet head 5 supported by a support unit 41, so as to form a pattern comprised of the dot-shaped ink. In doing so, the printing of the pattern is performed so that the droplet-shaped inkjet ink deposited on the surface S0 are separated from each other.

The ink-jet head 5 has a plurality of nozzles arrayed and fixed in one row or more rows in the whole width direction (direction perpendicular to A) of a region in which the reflective dots are formed on the surface of the transparent resin sheet 11, so as to oppose to the rear face S2 of the transparent resin sheet 11. The ink in the droplet state, which has been discharged from the plurality of the nozzles by an ink jet system, is simultaneously and collectively printed in the whole width direction of the transparent resin sheet 11. The ink is printed preferably while the transparent resin sheet 11 is continuously moved at a fixed speed. Alternatively, the ink can also be efficiently printed so as to have a pattern composed of a plurality of rows of dots, by repeating an operation of printing the ink in a state in which the transparent resin sheet 11 is stopped, moving the transparent resin sheet 11 to a next printing position, and stopping the movement.

The moving speed of the transparent resin sheet 11 is controlled so that the ink may be printed appropriately. In the case of the present embodiment, the ink-jet head 5 is constituted by a plurality of units having the plurality of the nozzles, respectively. The plurality of the units are arranged so that the end parts thereof overlap each other in a direction A of transporting the transparent resin sheet 11. Occasionally, the ink jet head may also be used which has a plurality of nozzles that are arranged in series, in the whole width direction of the region in which the reflective dots are formed on the surface of the transparent resin sheet.

In the case of the present embodiment, the ink can be collectively printed in the whole width direction of the transparent resin sheet 11, in a state in which the plurality of the nozzles of the ink-jet head 5 are fixed. Thereby, the productivity for the light guide plate is significantly enhanced compared to the case in which the ink is subsequently printed while a movable nozzle is moved along the width direction of the transparent resin sheet 11.

When a large-sized light guide plate having the transparent resin sheet with the length of 200 mm or longer and 1000 mm or shorter in a short side is manufactured, in particular, an effect of enhancing the productivity according to the method of the present embodiment is large. Furthermore, according to the ink jet method, even the fine reflective dots having, for instance, the largest diameter of 100 μm or less can be easily and accurately formed. When the transparent resin sheet is thin, the reflective dots can be seen through from the exit face S1 side, but the phenomenon can be prevented by making the reflective dots small.

The nozzle of the ink-jet head 5 is connected to an ink supply unit 50 through a duct 55. The ink supply unit 50 has, for instance, an ink tank in which an ink has been accommodated and a pump for sending the ink out. The plurality of the ducts 55 may be connected to a single ink tank, or may also be connected to a plurality of ink tanks, respectively.

The ink-jet ink which is used in ink jet printing to form the reflective dots 12 is an ultraviolet curing type ink which includes a pigment, a photopolymerizable component and a photopolymerization initiator.

The pigment is preferably at least any one of calcium carbonate particles, barium sulfate particles, and titanium dioxide particles. Respective cumulative 50% particle size D50 of the calcium carbonate particles, the barium sulfate particles, and the titanium dioxide particles range from 50 to 3,000 nm, more preferably from 100 to 1,500 nm, or even more preferably from 300 to 600 nm. Calcium carbonate particles, barium sulfate particles, and titanium dioxide particles having the cumulative 50% particle size D50 in a range from 50 to 3,000 nm can be obtained by appropriately selecting a product on the basis of a particle size distribution from commercialized products. The content ration of the pigment in the ink is usually approximately 0.5 to 15.0 mass % with reference to the total mass of the ink. An ink using a pigment that is at least any one of calcium carbonate particles, barium sulfate particles, and titanium dioxide particles is an ink using an inorganic substance. When considering a preservation stability or, in other words, an inorganic pigment sedimentation property of such an ink using an inorganic substance, an ink that uses calcium carbonate particles whose specific gravity is the smallest among the three particles as a pigment is most favorable.

The photopolymerizable component is comprised of a photopolymerizable monomer and/or a photopolymerizable oligomer which have a photopolymerizable functional group such as a vinyl group and which preferably does not have a hydroxyl group. The content ratio of the photopolymerizable monomer having no hydroxyl group is preferably 65 to 75 mass % with reference to the total mass of the ink. The content ratio of the photopolymerizable oligomer having no hydroxyl group is preferably 10 to 20 mass % with reference to the total mass of the ink.

The photopolymerizable monomer having no hydroxyl group is selected, for instance, from among 1,4-butanediol diacrylate (for instance, SR213 made by Sartomer Japan Inc.), 1,6-hexanediol diacrylate (for instance, SR238F made by Sartomer Japan, Inc.), 1,3-butylene diacrylate (for instance, SR212 made by Sartomer Japan Inc.), 1,9-nonanediol diacrylate (for instance, A-NOD-N made by Shin Nakamura Chemical Co., Ltd.), and propoxylated (2) neopentyl glycol diacrylate (for instance, SR9003 made by Sartomer Japan Inc.).

The photopolymerizable oligomer having no hydroxyl group preferably includes an aliphatic urethane(meth)acrylate (for instance, CN985B88 and CN991 made by Sartomer Japan Inc.). The aliphatic urethane(meth)acrylate is a photopolymerizable oligomer which has a polyurethane oligomer chain formed of an aliphatic polyisocyanate and an aliphatic polyol, and an acrylate group or a methacrylate group which is bonded thereto. The aliphatic urethane(meth)acrylate has a glass transition temperature preferably of 40° C. or higher.

The photopolymerization initiator can be appropriately selected from among photopolymerization initiators which are usually used in the field of an ultraviolet curing type resin. The content ratio of the photopolymerization initiator in the ink is usually approximately 0.5 to 10.0 mass % with reference to the total mass of the ink.

The ink jet ink may also include a component other than the pigment, the photopolymerizable component and the photopolymerization initiator in such a range as not to deviate from the spirit of the present invention.

A viscosity of the ink-jet ink at 50±10° C. is preferably 5.0 to 15.0 mPa·s, and more preferably 8.0 to 12.0 mPa·s. The viscosity of the ink jet ink can be adjusted, for instance, by a mass average molecular mass and/or a content ratio of the aliphatic urethane(meth)acrylate, When the mass average molecular mass and the content ratio of the aliphatic urethane(meth)acrylate increase, the viscosity of the ink tends to increase.

The absolute value |Δn| of the refractive index difference between the pigment and the photopolymerizable component after polymerization is normally 0.02≦|Δn|≦1.3, preferably 0.04≦|Δn|≦0.3, or more preferably 0.06≦|Δn|≦0.2. For example, when a photopolymerizable monomer and/or a photopolymerizable oligomer which does not have a hydroxyl group is used as the photopolymerizable component, the above conditions are satisfied by using at least any one of calcium carbonate particles (refractive index : n=1.59), barium sulfate particles (refractive index.: n=1.64), and titanium dioxide particles (refractive index: n=2.7), as the pigment.

A surface tension of the ink-jet ink at 25.0° C. is preferably 25.0 to 45.0 mJ/m², and more preferably of 25.0 to 37.0 mJ/m². The surface tension of the ink-jet ink can be adjusted, for instance, by blending a silicon-based surface active agent and a fluorine-based surface active agent into the ink.

The printed ink is cured in a region 70 by a UV lamp 7 which is supported by a support unit 42. Thereby, the reflective dots 12 constructed by the cured ink is formed.

After that, the light guide plate 1 is obtained through the step in which an inspection device 9 supported by a support unit 43 inspects the state of the formed reflective clots 12. The light guide plate 1 is cut off into a desired size, as needed. The light guide plate does not necessarily need to be continuously inspected by the inspection device provided in the downstream side of the ink jet head, as in the present embodiment, but the light guide plate can be also inspected off-line by an inspection device which has been separately prepared. Alternatively, the inspection step of the light guide plate by the inspection device can be occasionally omitted.

Normally, a printing pattern of ink that becomes the reflective dots 12 is designed to a desired pattern in which, a uniform planar light is efficiently emitted from the exit face S1. In addition, since ink is printed on the liquid repellent-treated surface S0, the reflective dots 12 are suppressed from connecting to each other. Therefore, a percentage of reflective dots 12 connected to each other can be set to the ranges described earlier. In this case, since an arrangement pattern of the plurality of reflective dots 12 more or less assumes a desired pattern, light supplied from the light source 3 to the transparent resin sheet 11 can be effectively extracted from the light-exit face S1. As a result, light can be emitted from the light-exit face S1 of the light guide plate 1 at a higher luminance. In addition, since an arrangement pattern of the reflective dots 12 is the desired pattern as described above, light can be emitted approximately uniformly from the light-exit face S1.

Since the surface light source device 20 comprises the light guide plate 1, the surface light source device 20 is capable of emitting light at a higher luminance. Furthermore, since the transmission-type image display device 100 is illuminated by light with higher luminance that is emitted from the surface light source device 20, an image with high display quality such as an image with more vivid contrast can be displayed.

### EXAMPLES

Hereinafter, the present invention will be described more specifically by citing examples. However, the present invention is not limited to these examples.

Light guide plates used in first to fifth examples and first to sixth comparative examples were prepared as follows.

### First Example

(1) Liquid Repellent Treatment Agent

A liquid repellent treatment agent was prepared by removing impurities by filtration from a mixture containing: 0.52 mass % of Megaface F-556 manufactured by DIC Corporation; 15.7 mass % of aliphatic polyurethane acrylate (CN985B88 manufactured by Sartomer Japan Inc.) as a photopolymerizable oligomer; 23.02 mass % of isobornyl acrylate (Light Acrylate IBXA manufactured by Kyoeisha Chemical Co., Ltd.) and 52.34 mass % of 1,4-butanediol diacrylate (SR213 manufactured by Sartomer Japan Inc.) as a photopolymerizable monomer; and 5.23 mass % of hydroxy hexyl phenylethyl ketone (Irgacure 184 manufactured by BASF Japan Ltd.), 3.14 mass % of phenyl his (2,4,6-trimethyl benzoyl) phosphine oxide (Irgacure 819 manufactured by BASF Japan Ltd.), and 0.05 mass % of 4,4′-[10-dioxo-1,10-decanediyl]-bis(oxy)bis[2,2,6,6-tetramethyl]-1-piperidinyloxy (Irgastab UV10 manufactured by BASF Japan Ltd.) as a photopolymerization initiator.

(2) Liquid Repellent Treatment of Transparent Resin Sheet

A 920 mm×520 mm PMMA resin sheet was prepared as a transparent resin sheet. Masking film was peeled off from the prepared PMMA resin sheet. Next, after spraying the prepared liquid repellent treatment agent on a surface exposed by peeling off the masking film, a liquid repellent treatment was performed by irradiating the surface sprayed by the liquid repellent treatment agent with ultraviolet light.

(3) Contact Angle

A contact angle of the liquid repellent-treated surface was measured using a pocket goniometer PG-X manufactured by Matsubo Corporation. Specifically, 2 μl of pure water was formed into a pendant-shaped drop at a tip of a drip nozzle, and a pure water droplet was dropped onto a surface S0 by lowering and raising the nozzle. The droplet immediately after being dropped was captured as a live image, whereby a static contact angle was automatically calculated by analyzing a droplet diameter and a droplet height of the droplet. The obtained contact angle was 95 degrees.

(4) LTV Curable Inkjet Ink

A pigment was dispersed by a beads mill disperser from a mixture containing: 9.52 mass % of calcium carbonate particles (Brilliant 1500 manufactured by Shiraishi Calcium Kaisha, Ltd.) as a pigment; 15.23 mass % of aliphatic polyurethane acrylate (CN985B88 manufactured by Sartomer Japan Inc.) as a photopolymerizable oligomer; 9.52 mass % of isobomyl acrylate (Light Acrylate TBXA manufactured by Kyoeisha Chemical Co., Ltd.) and 53.31 mass % of 1,4-butanediol diacrylate (SR213 manufactured by Sartomer Japan Inc.) as a photopolymerizable monomer; 4.76 mass % of hydroxy hexyl phenylethylketone (Irgacure 184 manufactured by BASF Japan Ltd,), 2.86 mass % of phenyl bis (2,4,6-trimethyl benzoyl) phosphine oxide (Irgacure 819 manufactured by BASF Japan Ltd.), and 0.04 mass % of 4,4′41-[10-dioxo-1,10-decanediyl]-bis(oxy)bis[2,2,6,6-tetramethyl]-1-piperidinyloxy (Irgastab UV10 manufactured by BASF Japan Ltd.) as a photopolymerization initiator; and 4.76 mass % of an organic polymer (SOLSPERSE 36000 manufactured by Lubrizol Japan Limited) as a pigment dispersant. Impurities were removed by filtration from the mixture after dispersion to obtain a UV curable inkjet ink.

A cumulative 50% particle size D50 (a volume mean particle size) of the calcium carbonate particles used as the pigment was measured by dynamic light scattering (photon correlation) using Malvern Zetasizer Nano S manufactured by Spectris Co., Ltd. Approximately 1 g of ink was diluted 100-fold into cyclohexanone to prepare a dispersing liquid for measurement. The dispersing liquid was irradiated by ultrasonic waves using an ultrasonic cleaner or a homogenizer for 10 minutes. Next, the dispersing liquid was placed in a sample input port of the Zetasizer Nano S to measure a particle size and a volume of the pigment. D50 represents a particle size at a point where a cumulative volume equals 50% of a total volume of all particles when a particle size and a volume are Pleasured for all particles and the volumes are sequentially cumulated starting with a particle with the smallest particle size. The pigment had a D50 of 685 nm.

The ink had a viscosity of 10.7 mPa·s at 40° C. and a surface tension of 37.0 mJ/m² at 25° C.

(5) Small Sample for Measurement of Spectral Transmittance

The obtained ink was applied using a bar coater to an entire one surface of a 50 mm by 50 mm, 4 mm-thick PMMA resin sheet. The applied ink was cured by ultraviolet irradiation to obtain a small sample for a measurement of spectral transmittance having a reflective coating formed by the ink. A thickness of the reflective coating of the obtained sample was measured as 4.5 μm using a Dektak (Large Sample Profiler FP10 manufactured by Toho Technology Corporation). Ultraviolet irradiation conditions were as follows.

### <Ultraviolet Irradiation Conditions>

Lamp: two metal halide lamps (concentrating-type)
Output: 120 W/cm
Irradiation time: 0.5 seconds
Irradiation distance: focal length+10 mm

(6) Manufacture of Light Guide Plate

A light guide plate was manufactured using a PMMA resin sheet as a transparent resin sheet and a UV curable inkjet ink prepared as described above.

Specifically, first, the UV curable inkjet ink was printed in a pattern by inkjet printing on a liquid repellent-treated surface of the PMMA resin sheet. Next, ultraviolet rays were irradiated on the printed inkjet ink and the ink was photo-cured to form reflective dots. In the first example, ultraviolet rays were irradiated 2 seconds after the UV curable inkjet ink was printed in a pattern on the PMMA resin sheet to photo-cure the ink. As a result, a light guide plate having a plurality of reflective dots was obtained. Printing conditions and ultraviolet irradiation conditions were as follows.

### <Printing Conditions>

Nozzle diameter: 30 μm
Applied voltage: 20 V
Pulse width: 40 μs
Drive frequency: 2,500 Hz
Heating temperature: 40° C.

### <Ultraviolet Irradiation Conditions>

Lamp: two metal halide lamps (concentrating)
Output: 120 W/cm
Irradiation time: 0.5 seconds
Irradiation distance: focal length+10 mm

### Second Example

A light guide plate was obtained in the same manner as in the first example with the exception of using a UV curable inkjet ink prepared by changing the pigment to 9.52 mass % of calcium carbonate particles (Silver W manufactured by Shiraishi Calcium Kaisha, Ltd.). The used pigment had a D50 of 350 nm.

The ink had a viscosity of 10.7 mPa·s at 40° C. and a surface tension, of 37.0 mJ/m² at 25° C.

Using the obtained ink, a small sample for a measurement of spectral transmittance having a reflective coating formed by the ink was obtained by the same method as in the first example. The reflective coating of the obtained sample had a thickness of 4.8 μm. The thickness of the reflective coating was measured by the same method as in the first example.

### Third Example

A light guide plate was obtained in the same manner as in the first example with the exception of using a UV curable inkjet ink prepared by changing the pigment to 9.52 mass % of barium sulfate particles (Precipitated Barium Sulfate 100 manufactured by Sakai Chemical Industry Co., Ltd.). The used pigment had a D50 of 324 nm.

The ink had a viscosity of 8.6 mPa·s at 40° C. and a surface tension of 37.0 mJ/m² at 25° C.

Using the obtained ink, a small sample for a measurement of spectral transmittance having a reflective coating formed by the ink was obtained by the same method as in the first example. The reflective coating of the obtained sample had a thickness of 4.5 μm. The thickness of the reflective coating was measured by the same method as in the first example.

### Fourth Example

A light guide plate was obtained in the same manlier as in the first example with the exception of using a UV curable inkjet ink prepared by changing the pigment to 9.52 mass % of titanium dioxide particles (Titanium Oxide TIPAQUE R-820N manufactured by Ishihara Sangyo Kaisha, Ltd.). The used pigment had a D50 of 433 nm.

The ink had a viscosity of 8.3 mPa·s at 40° C. and a surface tension of 37.0 mJ/m² at 25° C.

Using the obtained ink, a small sample for a measurement of spectral transmittance having a reflective coating formed by the ink was obtained by the same method as in the first example. The reflective coating of the obtained sample had a thickness of 4.7 μm. The thickness of the reflective coating was measured by the same method as in the first example.

### Fifth Example

A light guide plate was obtained in the same manner as in the first example with the exception of using a UV curable inkjet ink prepared by changing the pigment to 9.52 mass % of titanium dioxide particles (Titanium Oxide JR-1000 manufactured by Tayca Corporation). The used pigment had a D50 of 643 nm.

The ink had a viscosity of 8.3 mPa·s at 40° C. and a surface tension of 37.0 mJ/m² at 25° C.

Using the obtained ink, a small sample for a measurement of spectral transmittance having a reflective coating formed by the ink was obtained by the same method as in the first example. The reflective coating of the obtained sample had a thickness of 4.2 μm. The thickness of the reflective coating was measured by the same method as in the first example.

### Sixth Example

### <Liquid Repellent Treatment of Transparent Resin Sheet by Using Energy Ray>

A 600 nm×345 mm PUMA resin sheet was prepared as a transparent resin sheet. Masking film was peeled off from the prepared PMMA resin sheet. Next, while a mixed gas of carbon tetrafluoride gas and argon gas was supplied into a direct-type plasma processing apparatus as the liquid repellent treatment agent, and the PMMA resin sheet from which the masking film was peeled off was conveyed into the apparatus at a line speed of 5 m/min, a liquid repellent treatment was performed by irradiating the surface exposed by peeling off the masking film with plasma. The flow rate of the argon gas and the carbon tetrafluoride gas was 150 m³/min and 0.5 m³/min, respectively.

A contact angle on the liquid repellent-treated surface was measured in the same manner as in the first example. The obtained contact angle was 93.2 degrees.

A light guide plate was obtained in the same manner as hi the first example with the exception of performing the liquid repellent treatment by the energy ray, as the liquid repellent treatment.

### First Comparative Example

In the first comparative example, the PMMA resin sheet used in the first example was used as a transparent resin sheet without subjecting the PMMA resin sheet to a liquid repellent treatment. A measurement of a contact angle on a surface of the PMMA resin sheet not liquid repellent-treated which was performed in the same manner as in the first example resulted in a contact angle of 75 degrees. A UV curable inkjet ink for forming reflective dots was prepared in the same manner as in the first example. The UV curable inkjet ink was printed in a pattern by inkjet printing on one surface of the PMMA, resin sheet. Next, ultraviolet rays were irradiated on the printed inkjet ink and the ink was photo-cured to form reflective dots. In the first comparative example, ultraviolet rays were irradiated 2 seconds after the UV curable inkjet ink was printed in a pattern on the PMMA resin sheet to photo-cure the ink in the same manner as in the first example. As a result, a light guide plate having a plurality of reflective dots was obtained. Printing conditions and ultraviolet irradiation conditions were as follows.

### <Printing Conditions>

Nozzle diameter: 30 μm
Applied voltage: 20 V
Pulse width: 40 μs
Drive frequency: 2,500 Hz
Heating temperature: 40° C.

### <Ultraviolet Irradiation Conditions>

Lamp: two metal halide lamps (concentrating)
Output: 120 W/cm
Irradiation time: 0.5 seconds
Irradiation distance: focal length+10 mm

### Second Comparative Example

A light guide plate was obtained in the same manner as in the first comparative example with the exception of using a UV curable inkjet ink prepared in the same manner as in the second example.

### Third Comparative Example

A light guide plate was obtained in the same manner as in the first comparative example with the exception, of using a UV curable inkjet ink prepared in the same manner as in the fifth example.

### Fourth Comparative Example

A light guide plate was obtained in the same manner as in the first comparative example with the exception of irradiating ultraviolet rays 60 seconds after the UV curable inkjet ink was printed in a pattern on the PMMA resin sheet to photo-cure the ink. With the manufacture of the light guide plate according to the fourth comparative example, almost all of the UV curable inkjet ink printed in a pattern became connected to each other to form a film before the ultraviolet rays were irradiated. Therefore, with the light guide plate according to the fourth comparative example, a film of photo-cured ink was formed.

### Fifth Comparative Example

A light guide plate was obtained in the same manner as in the fourth comparative example with the exception of using a UV curable inkjet ink prepared in the same manner as in the second example. With the light guide plate according to the fifth comparative example, a film of photo-cured ink was formed in the same manner as in the fourth comparative example.

### Sixth Comparative Example

A light guide plate was obtained in the same manner as in the fourth comparative example with the exception of using a UV curable inkjet ink prepared in the same manner as in the fourth example. With the light guide plate according to the sixth comparative example, a film of photo-cured ink was formed in the same manner as in the fourth comparative example.

### Seventh Comparative Example

In the seventh comparative example, a light guide plate was obtained in the same manner as in the first example with the exception of using the PMMA resin sheet used in the sixth example as a transparent resin sheet without subjecting the PMMA resin sheet to a liquid repellent treatment. A contact angle on the PMMA resin sheet which was not subjected to a liquid repellent treatment was measured in the same manner as in the first example. The obtained contact angle was 75 degrees.

Next, a yellow index (YI) was obtained using the small samples for measurement of spectral transmittance prepared in the first to fifth examples, and luminance was measured on the light guide plates prepared in the first to sixth examples and in the first to seventh comparative examples.

<Measurement of Yellow Index (YI)>

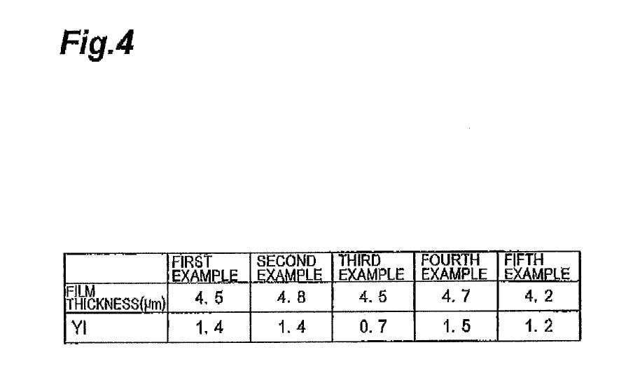

A spectral transmittance of light transmitted through the small samples for measurement of spectral transmittance prepared in the first to fifth examples was measured in a wavelength range of 300 nm to 800 nm using a spectral transmissometer with an integrating sphere (U-4100 manufactured by Hitachi, Ltd.). A yellow index (YI) was obtained from the measurement results. FIG. 4 is a table showing a result of yellow index measurement. As is apparent from FIG. 4, values of YI in the first to fifth example are equal to or lower than 10. Natural color tone light can be obtained when such a YI is achieved.

<Luminance Measurement>

Two diffusion films, one prism film, and a light guide plate were removed from a surface light source device of a commercially-available liquid crystal display device (40-Inch) to prepare a frame in, which a plurality of LEDs are arranged as a light source. After building the light guide plates respectively prepared in the first to fifth examples and the first to sixth comparative examples into the frame, two diffusion films and one prism film were overlapped onto the light guide plates and then fixed to the frame. The LEDs were lighted in this state and a measurement was performed using a luminance meter (Two-dimensional Chromaticity/Luminance Meter CA-2000 manufactured by Konica Minolta Holdings, Inc.) positioned so as to oppose the prism film. As to the first to fifth examples and the first to sixth comparative examples, an in-plane average luminance was measured from measured values at a total of 884×502 measurement points or, namely, 884 measurement points in a long side-direction of the light guide plate by 502 measurement points in a short side-direction of the light guide plate.

<Luminance Measurement>

Two diffusion films, one prism film, and a light guide plate were removed from a surface light source device of a commercially-available liquid crystal display device (26-Inch) to prepare a frame in which a plurality of LEDs are arranged as a light source. After building the light guide plates respectively prepared in the sixth example and the seventh comparative example into the frame, two diffusion films and one prism film were overlapped onto the light guide plates and then fixed to the frame. The LEDs were lighted in this state and a measurement was performed using a luminance meter (Two-dimensional Chromaticity/Luminance Meter CA-2000 manufactured by Konica Minolta Holdings, Inc.) positioned so as to oppose the prism film. As to the sixth example and the seventh comparative example, an in-plane average luminance was measured from measured values at a total of 574×324 measurement points or, namely, 574 measurement points in a long side-direction of the light guide plate by 324 measurement points in a short side-direction of the light guide plate.

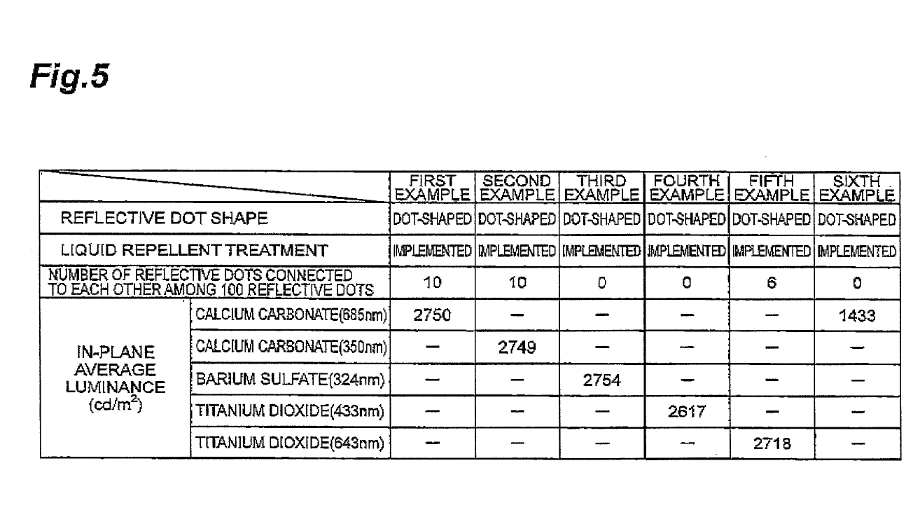

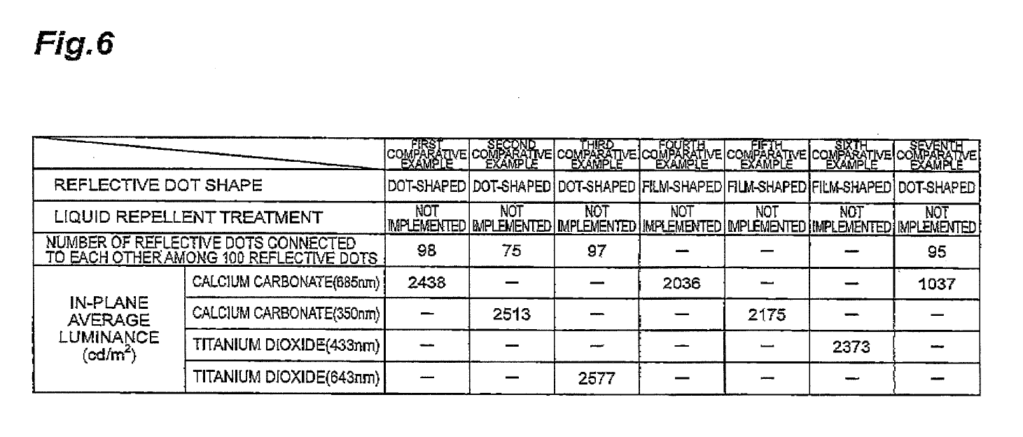

FIG. 5 is a table showing results of luminance measurements of the first to sixth examples. FIG. 6 is a table showing results of luminance measurements of the first to seventh comparative examples. The tables shown in FIGS. 5 and 6 present a composition of ink together with a cumulative 50% particle size D50 of a pigment, as well as whether or not a liquid repellent treatment has been performed. In FIGS. 5 and 6, “Implemented” means that a liquid repellent treatment has been performed on a surface of a PMMA resin sheet on which reflective dots are to be formed, and “Not Implemented” means that a liquid repellent treatment has not been performed on the surface of the PMMA resin sheet on which reflective dots are to be formed. FIGS. 5 and 6 also present a shape of the reflective dots formed on the light guide plate and a percentage of the reflective dots formed on the light guide plate which are connected to each other. The percentage of the reflective dots connected to each other was evaluated by the number of connected reflective dots among 100 reflective dots positioned at a central portion of the surface of the light guide plate on which the reflective dots were formed. The term “Film-shaped” corresponding to the fourth to sixth comparative examples means that UV curable inkjet ink has formed a film.

A comparison between the first to sixth examples and the first to seventh comparative examples reveals that an in-plane average luminance of a case where dot-shaped reflective dots are formed is improved over a case where a film of photo-cured ink is formed. In addition, a comparison between the first to sixth examples in which a liquid repellent treatment had been performed and the first, second, third, and seventh comparative examples in which a liquid repellent treatment had not been performed reveals that, as shown in FIGS. 5 and 6, adjacent reflective dots are suppressed from connecting with each other by performing the liquid repellent treatment. The in-plane average luminance of the first to sixth examples in which a liquid repellent treatment had been performed had improved over the in-plane average luminance of the first, second, third, and seventh comparative examples. In other words, it was confirmed that the present invention enables light from a light-emitting surface of a light guide plate to be emitted at a higher luminance.

Although the present invention has been described above in its embodiment and examples, the present invention is not limited to the embodiment and the examples and various modifications may be made without departing from the spirit or scope of the present invention. For example, the embodiment described above exemplifies a case where light sources 3 are respectively arranged to the side of end faces S3₁ and S3₂ that oppose each other. However, a light source 3 need only be arranged to the side of at least one end face that intersects the light-exit face S1 (or the rear face S2) of the transparent resin sheet 11.

The present invention is able to provide a light guide plate capable of emitting light from a light-emitting surface at a higher luminance, a surface light source device and a transmission-type image display device comprising the light guide plate, a light guide plate manufacturing method, and a UV curable inkjet ink for the light guide plate.

1. A light guide plate comprising:
a transparent resin sheet having a light-emitting surface that emits light incident from an end face and having a rear face on the opposite side of the light-emitting surface; and
a plurality of reflective dots provided on the rear face of the transparent resin sheet and formed by photo-curing of dot-shaped ink, wherein
the ink contains a pigment, a photopolymerizable component, and a photopolymerization initiator, and
the rear face is a liquid repellent-treated surface.

2. The light guide plate according to claim 1, wherein the rear face is a surface that is liquid repellent-treated so that a droplet of water dropped on the rear face has a contact angle of 80 to 130 degrees.

3. The light guide plate according to claim 1, wherein the transparent resin sheet is constituted by polymethyl(meth)acrylate.

4. The light guide plate according to claim 1, wherein the liquid repellent treatment is at least one of a treatment in which a liquid repellent treatment agent is applied, a plasma treatment, and surface roughening.

5. The light guide plate according to claim 1, wherein a percentage of adjacent reflective dots connected to each other is 0 to 30 per 100 reflective dots.

6. The light guide plate according to claim 1, wherein
a maximum thickness of the reflective dots is 20 μm or less, and
a yellow index evaluated on the basis of the transmittance measurement of a light that transmits through the reflective dot and the transparent resin sheet is 10 or less.

7. A method of manufacturing light guide plate comprising the steps of:
performing liquid repellent treatment on one surface of a transparent resin sheet;
printing a pattern with the ink on the one liquid repellent-treated surface by inkjet printing; and
forming reflective dots by photo-curing the printed pattern of ink, wherein
the ink contains a pigment, a photopolymerizable component, and a photopolymerization initiator.

8. The method according to claim 7, wherein in the step of performing a liquid repellent treatment, the liquid repellent treatment is performed so that a droplet of water dropped on the one surface has a contact angle of 80 to 130 degrees.

9. A surface light source device comprising:
the light guide plate according to claim 1; and
a light source for supplying light to the end face of the transparent resin sheet included in the light guide plate.

10. A transmission-type image display device comprising:
the light guide plate according to claim 1;
a light source for supplying light to the end face of the transparent resin sheet included in the light guide plate; and
a transmission-type image display unit illuminated by light emitted from the light-emitting surface of the transparent resin sheet included in the light guide plate.

11. A ultraviolet curing type ink-jet ink for a light guide plate which is applied to become reflective dots on one liquid repellent-treated surface of a transparent resin sheet, wherein
the ultraviolet curing type ink-jet ink contains a pigment, a photopolymerizable component, and a photopolymerization initiator, and
the pigment is at least one of calcium carbonate particles, barium sulfate particles, and titanium dioxide particles.

12. The ultraviolet curing type ink-jet ink for a light guide plate according to claim 11, wherein a cumulative 50% particle size of the pigment ranges from 50 to 3,000 nm.

13. The light guide plate according to claim 2, wherein the liquid repellent treatment is at least one of a treatment in which a liquid repellent treatment agent is applied, a plasma treatment, and surface roughening.

14. The light guide plate according to claim 3, wherein the liquid repellent treatment is at least one of a treatment in which a liquid repellent treatment agent is applied, a plasma treatment, and surface roughening.
